(19) United States
(12) Patent Application Publication
(10) Pub. No.: US 2006/0282274 A1
(43) Pub. Date: Dec. 14, 2006

(54) Monitoring and managing farms

(76) Inventor: Michael S. Bennett, Bristol (GB)

Correspondence Address: Brooks & Cameron, PLLC;Suite 500, 1221 Nicollet Avenue, Minneapolis, MN, 55403, US

(21) Appl. No.: 11/157,037

(22) Filed: Jun. 20, 2005

(30) Foreign Application Priority Data
Jun. 10, 2005 (GB) GB0511891.4

(51) Int. Cl. G06Q 99/00; G06F 15/02; G07G 1/00

(52) U.S. Cl. 705/1; 705/9; 705/10

(57) ABSTRACT

A method of managing a farm includes preparing a farm management protocol and a code of practice and managing the farm in accordance with these documents. The farm management protocol includes instructions for farmers on the use of inputs to the farm to ensure that the outputs of the farm are of a particular quality and specification. The code of practice provides farming guidelines to ensure that application of the farm protocol will result in the particular outputs being achieved reliably. A system for monitoring the inputs and outputs of the farm is also provided to ensure that the farm management protocol is being followed and to enable changes to the protocol to be made as required.

This application is a continuation under 35 USC 111(a) OF GB0511891.4, filed Jun. 10, 2005, which application is incorporated by reference.

The present disclosure relates to a computer system for monitoring and managing one or more farms.

In the UK, current legislation requires every farmer to have some kind of recording system for documenting events on farm, such as delivery of feed, a calf being born or a beef animal being sold for slaughter. All farms are obliged to keep records on farm of all feedstuffs, drugs and chemicals received and used on farm. However, there are no national or international standalone recording systems that allow farmers to document this information consistently. Only partial systems for recording data currently exist.

For example, 60% of dairy farms in the UK currently herd record through organisations such as National Milk Records. Herd recording is a system set up to capture mainly production and efficiency data through measurement of individual milk yields, butterfats, proteins etc. It also captures event data on farms such as calvings, culls, and delivery of feeds, drugs and so forth. The other 40% of dairy farms that do not herd record therefore become a problem.

In the event of an alert where a contaminated material has been used in the supply chain and may have been used on a farm, it is important to be able to trace the contaminated material through the supply chain so that all affected parties, such as farmers and end consumers, can be quickly informed. Potentially contaminated animals, crops or food products can then be removed from the chain.

One existing alert process which involves farmer self-certification proceeds as follows:

1. All farmers are contacted individually by telephone or post with a list of the potentially contaminated substances. The enquirer may be government inspector or customer who buys from the farmer.

2. The farmer checks through his own records to establish whether the substance has been delivered to the farm. The farmer may then copy all his relevant farm records and send them along with a self certification document back to the enquirer.

An alternative process involves farm visits by a suitably qualified person to check farm records and proceeds as follows:

1. All farmers are again contacted individually by telephone or post with a list of the potentially contaminated substances. The enquirer may be government inspector or customer who buys from the farmer.

2. An inspector representing the enquirer arranges to visit the farm and to check and validate all relevant paperwork.

3. Where records are incomplete or not up to date (as is often the case), the farmer contacts individual suppliers to obtain complete and up to date information.

4. Farm suppliers will in turn conduct an audit of their own stocks and deliveries and pass the necessary information back up through the supply chain.

Only once one of the above processes has been completed for all potentially contaminated farms can supply recommence. These processes are time consuming, particularly when a large number of farms might be affected. The consequence of delays in obtaining the results is the suspension of supply from all potentially contaminated farms. This has very negative implications for the whole supply chain through loss of supply.

According to various embodiments of the present disclosure, there is provided a method, including program instructions, which are executable for managing a farm comprising: determining a particular output for a farm; developing a farm management protocol; developing a code of practice; tracing inputs to and outputs from the farm; managing the inputs to the farm under the farm management protocol and the code of practice in order to achieve the particular output for the farm. Accordingly, the present embodiment provides a farm management scheme which ensures traceability of inputs and outputs as well as permitting centralised control of farming on one or more different farms to ensure consistent quality and product of outputs.

In one embodiment, the farm management protocol comprises a list of particular suppliers of inputs to the farm. This ensures that the inputs to the farm can be carefully monitored and will be of acceptable quality.

In one embodiment, the farm management protocol comprises guidelines for recording the inputs to and outputs from the farm. This aids in ensuring that inputs and outputs can be traced to an acceptable level of accuracy.

In one embodiment, the farm management protocol comprises guidelines for regular testing of the outputs from the farm. This ensures that the outputs from the farm are as particular. The farm management protocol or code of practice can then be modified if the output is not the particular output.

Various embodiments of the present disclosure provides a computer system for monitoring a farm, comprising: an inputs module for receiving data relating to inputs to the farm; an outputs module for receiving data relating to outputs from the farm; and a report generation module for generating at least one report relating to the inputs to and outputs from the farm. This second aspect of the present embodiment ensures that any required information concerning the inputs to and outputs from a farm can be quickly retrieved in a report.

The modules mentioned herein include one or more integrated circuits or other structures that operate on program instructions, i.e., software and/or firmware, to perform the operations described herein. The embodiments of the invention, however, are not limited to any particular computer operating environment or to instructions written in a particular programming language. Software, firmware, and/or processing modules, suitable for carrying out embodiments of the present invention, can be resident in one or more devices or locations. Processing modules can include separate modules connected together or include several modules on an application specific integrated circuit (ASIC).

In one embodiment, the at least one report is a forecast of future inputs to and outputs from the farm. In this way, a long term plan for modifying the inputs to the farm to obtain a particular output can be developed.

In one embodiment, the at least one report is a report showing a distribution of a contaminated substance in a supply chain. In this way, accurate traceability is ensured in the event of a contaminated substance entering the supply chain.

In one embodiment, the data relating to inputs to the farm is received from suppliers supplying the inputs to the farm and is further received from the farm on a regular basis. This ensures that accurate records of the inputs to the farm are kept.

In one embodiment, the system further comprises a web server for storing the reports and making them accessible via a computer network. In this way, farmers, suppliers and any other suitably authorised parties can review the data relating to inputs and outputs of the farm and can assess the quality of the outputs or check quickly check for the presence of contaminated substances, for example.

In various embodiments, the present disclosure provides a method for monitoring inputs to a farm, including: communicating information identifying inputs to a farm from the farm and from a supplier of inputs to the farm to an auditing facility; and auditing inputs to the farm at the auditing facility. This embodiment of the present disclosure can aid to ensure that accurate records of inputs to a farm or to a plurality of different farms are kept at a central auditing facility. A suitably authorised person wishing to monitor the inputs to the farm or farms has a central resource which they can use rather than investigating the records of each farm directly.

In one embodiment, the auditing facility is independent of the farm and of the supplier to ensure that impartial records of inputs to the farm are kept.

In one embodiment, the information is communicated to the auditing facility electronically, e.g., by email. In this way, the record at the auditing facility can be kept up to date as much as possible. This can be further achieved by the supplier communicating information identifying inputs to the farm at the time of dispatch to the farm of the inputs.

On one level, embodiments of the present disclosure provide a farm management system that affords traceability and accountability in farm production. Embodiments of the present disclosure can add value to farm production or farm outputs. In one embodiment, value is added to milk production and milk products from the farm upwards. Thus, the various embodiments include developing, implementing and running on-farm traceability and management systems (including executable program instructions) which can facilitate developing markets for functional farm products, such as milk of a particular specification.

Various embodiments of the farm management system include:

1. A Code of Practice;

2. A Traceability System; and

3. A Farm Management Protocol.

The code of practice and farm management protocol provide guidelines and instructions for running a farm and for obtaining and using inputs to the farm such as feed, fertiliser, drugs, veterinary services and so forth.

In various embodiments, the farm management protocol includes the following:

Methodology for producing farm outputs (such as milk) of a consistent quality and quantity as if you were in a factory.

Ability to micro-analyse data remotely from the farm to make management decisions.

Produces financial KPIs (Key Production Indices) for real-time use on farm.

Promotes integration of farm professionals on farm to make consistent management decisions.

Using a traceability system to audit nutritional inputs against actual consumption on farm, thereby giving a very accurate view on how inputs are used.

Creation of one big farm from a lot of smaller ones, farming and producing in the same consistent fashion.

Embodiments of the present disclosure also provide a traceability system. The traceability system is a tracking system providing total real-time traceability for animals or products on and off the farm. Existing tracking systems only operate on a ‘one up, one down’ basis such that the supply chain does not have complete visibility of the supplies and suppliers.

In the event of an alert concerning a contaminated material which may have entered the supply chain, the suspected contaminated material is input into a database of farm suppliers and a record of farms who have received the contaminated substance is immediately available. For example, the search can be conducted by product, by supplier name and by date, or by any combination or search terms. This facility allows a list of affected farms to be quickly drawn up and for them to be quarantined out of the supply chain with immediate effect. The farm need not even be contacted for the quarantine to be activated since purchasers (e.g. milk processors) of products from the affected farms need only alert their processing facilities to stop taking deliveries from the affected farms.

Various embodiments of the present disclosure will now be described by way of an example and with reference to the accompanying drawings, in which:

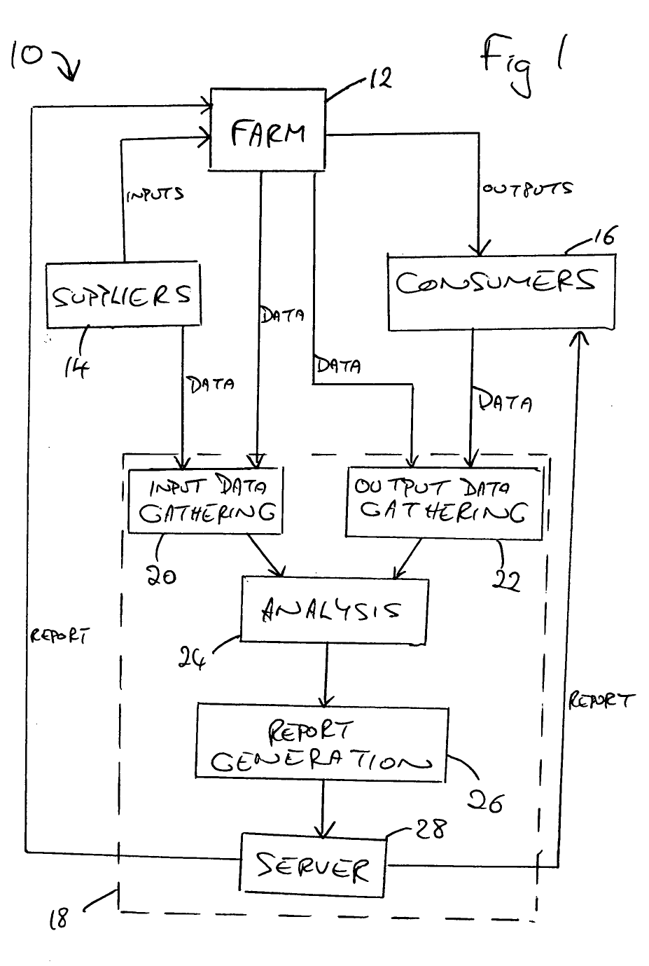

FIG. 1 illustrates an embodiment of a farm management system; and

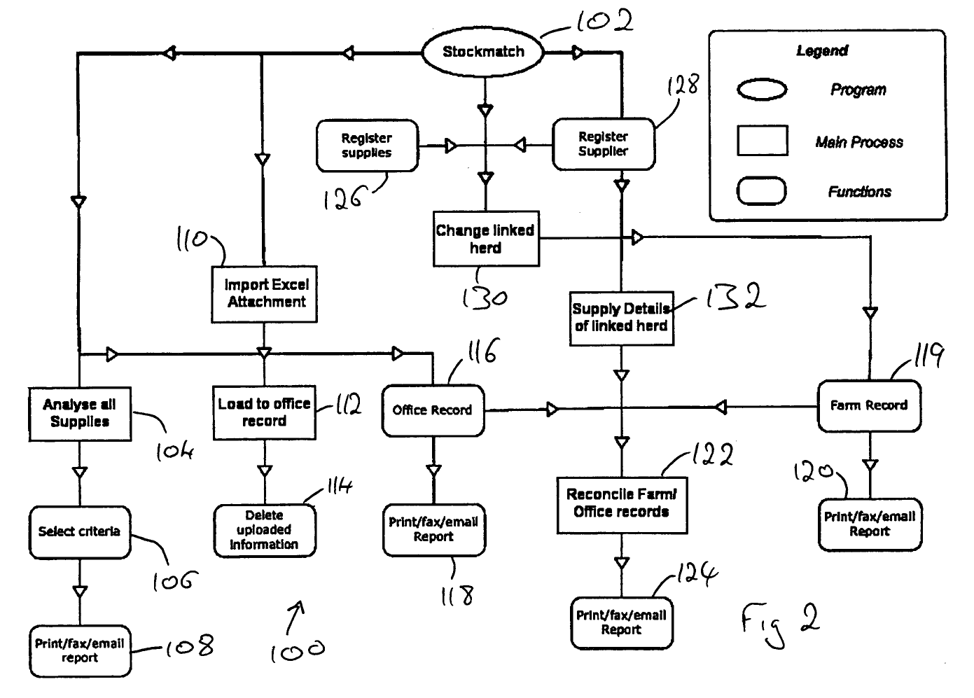

FIG. 2 illustrates an embodiment of a computer program process performed by executable program instructions.

In a farm monitoring system and method embodying the present disclosure, there are a number of capabilities which can be achieved, including by way of example and not by way of limitation:

1. Traceability of inputs and outputs of farms and the creation of an information database.

2. Adherence to legislation and foresight for change.

3. Integration of key entities that have direct and indirect influence on farm profitability.

4. Control of nutritional and other inputs.

5. Generation of data that can be used interactively.

6. Interpretation of data that can be used to influence management decisions remotely.

7. Standardisation of farming methods such as the use of farm inputs for consistent farm output.

FIG. 1 illustrates a system 10 which permits embodiments of the present disclosure to achieve various capabilities. At the centre of the system is the farm 12, which receives inputs from suppliers 14 and provides outputs to consumers 16. The farm 12 may be a crop farm, or an animal farm producing animals and/or animal products. For the purposes of illustrating the present disclosure, an example of the operations of a dairy farm will be described. The suppliers 14 may be suppliers of seeds, pesticides, feed, micro-nutritional ingredients, pharmaceuticals, fertiliser, veterinary services, breeding services, hygiene services and so forth depending upon the requirements of the farm 12. The consumers 16 need not be the end consumers, but may be any entity that receives outputs from the farm, such as testing laboratories, supermarket suppliers, milk purchasers and so forth.

In order to monitor the inputs and outputs of the farm, an auditing facility 18 receives and processes information provided to it by the suppliers 14, the farm 12 and the consumers 16. Typically a single auditing facility will monitor many farms, but a single farm is shown in FIG. 1 for simplicity. The auditing facility can include an input data system 20 for gathering data concerning inputs to the farm 12 and an output data system 22 for gathering data concerning outputs from the farm 12. The auditing facility 18 will also gather data concerning how inputs are used on the farm such as how much of a particular pharmaceutical is given to how many (and which) cows on a dairy farm. The gathered data may be stored to ensure that there is traceability and accountability at all levels of the farming process. The data gathered by the input and output data system 20, 22 will be analysed 24 by the auditing facility and suitable reports will be generated 26. These reports may include recommendations for changing the inputs to the farm 12 to improve or alter the quality of the outputs according to particular goals of the farm 12 or the consumers 16. Other reports may be generated as particular. The reports and any other data gathered by the auditing facility may then be put onto a server 28, such as a web server, which can be accessed by the farm 12 or the consumers 16 over a computer network such as the Internet.

The auditing facility 18 has various controls over the farming process and monitors the gathered data to ensure that outputs of adequate quality or of a particular specification are being delivered to consumers 16. The auditing facility 18 may itself be under the control of a consumer 16 since the consumer would have a vested interest in ensuring that the outputs of the farm 12 are of acceptable quality or of the particular type. The auditing facility 18 initiates and/or enforces farm management protocols and codes of practice to be followed by suppliers 14, consumers 16 and farms 12 to ensure that the particular outputs are achieved.

Capabilities associated with one protocol to be enforced by an auditing facility 18 in connection with the system illustrated in FIG. 1 are presented in connection with the following discussion.

1. Suppliers

Suppliers 14 to farms 12 are can be known to the auditing facility 18 so that the auditing facility 18 can gather the required information regarding inputs to the farm 12 from the suppliers. In various embodiments, only a limited number of suppliers 14 agreed to by the auditing facility 18 are used by the farm 12. The reason to have particular suppliers is to limit the sources of commodity inputs onto farms so as to have greater control over the quality, specification and traceability. If farms 12 are given too much choice of supply of similar products they will be driven by a number of emotional factors which may ultimately have a detrimental effect on standardising the outputs of the farm, such as the quality or quantity of milk.

Any minute changes to the input commodities or products could be influential on the outputs of the farm 12, such as milk specification, as stated above, but may also impact on a number of knock-on factors, e.g. health, fertility, and longevity of animals.

As an example, there are six main supply areas that will have a direct or indirect influence over performance and profitability on a dairy farm 12.

(i) Pesticides

A small number of pesticide and agronomy companies will be particular in each territory for supply of commodity pesticides and agronomy advice to individual farmers.

The design is for agreed active ingredients for chemicals to be used (if needed) consistently by all farms 12 on crops that are part of the dairy cow diet. Certain chemicals will not be allowed to enter the system because of risks with residue levels left in the finished feed or any other environmentally driven issues.

Agronomists will be supplied with a set of guidelines to work to that will achieve broadly consistent feed materials across the protocol group of farms 12. These guidelines will include interaction with the nutrition and veterinary inputs so as to understand which feed stuffs are required, quantities and qualities, etc.

According to various embodiments, the farm 12 will behave like a contractor to grow crops of a type and specification that suits the production of milk to be sold.

(ii) Micro-Nutritional Ingredients

Having particular suppliers of micro-ingredients can be advantageous as this area potentially aids in enhancing milk and dairy product value.

The nutrition technologist will be expected to be a conduit between the milk buyer 16 and the farm 12.

The ingredients to be approved are, for example, vitamins, minerals, fatty acids. All of these would amount to a small percentage of the total diet but are the most pivotal part of enriching milk.

The ration for each herd will be formulated at this juncture by the auditing facility 18 using further information from other particular suppliers 14, such as forages produced by the agronomist, feed ingredients by the commodity supplier, veterinary inputs, and so forth.

Legislation around these micro-ingredients is ever changing, so again the supplier 14 would be expected to furnish the auditing facility 18 with up to date information at all times and also to make sure that labelling of ingredients is legally correct.

(iii) Pharmaceuticals

There will be a list of active ingredients that will be allowed to be administered on a farm 12—and others that will be outlawed. As with the pesticides, residues are an issue but more importantly there are certain drugs that do not show up on antibiotic tests, thus not giving particular traceability.

Pharmaceuticals will be prescribed centrally to participants of the protocol, so as to control their use.

There are, for example, four separate pharmaceutical distributors in the UK who could deliver product to prescribe through a veterinary module of the system 10 to farms 12 for use.

(iv) Commodity Inputs (e.g. seeds, fertilisers and feed)

This will be the largest bulk area but will typically be the simplest to control.

A number of suppliers 14 will be allowed as long as they adhere to all current legislation, e.g. UKASTA feed assurance scheme.

Technical advice will not be part of this area, only ordering on the back of the protocol being followed fully.

Certain feed ingredients will be allowed and others not, again to give the auditing facility 18 control over dietary intakes.

Fertiliser applications on land that is used for production of crops for use within the protocol will be strictly monitored by the agronomist and again will be guided by market parameters, e.g. selenium enriched milk will be influenced by the amount of selenium used in fertiliser on crops to be fed to cows.

Seeds will be agreed, again with the agronomy team, to create consistent bulk delivery. Grass and maize, for example, would be the major inclusions of diets on a farm in the UK—about 50% of the dry matter intake—but protein and fibre levels differ between varieties.

If particular ingredients, such as genetically modified ingredients, are outlawed by the market for any reason, the feed, seed and fertiliser suppliers 14 would have to be able to show a robust audit trail to prove that all deliveries to farms 12 conformed to this specification.

(v) Veterinary

Particular veterinary surgeons will be used as consultants on farms 12 to do daily or weekly work, but more to assess interactively with the nutritionist and agronomist the performance of the protocol on farms 12.

The inputs by vets will be influenced by the reports 26 generated by the auditing facility 18.

The other area of veterinary input will be emergency out-of-hours work—this might or might not be performed by the same person as the consultant, depending on circumstances.

Examples of things that will require veterinary input include: fertility, health generally, hygiene of milk and other metabolic disorders that could influence nutritional performance.

(vi) Breeding

A particular supplier 14 will be used for breeding services for certain outcomes in milk specification. If there are consistent or standard cows across the board, producing a consistent product would be that much easier.

Breeding cows for certain genotypes (e.g. higher fat composition), is eminently possible but using this information in conjunction with nutrition and veterinary input should make selection of animals even more specific for the job in hand.

All of the above areas can aid production of specific types or specifications of milk. With this goal in mind, the particular suppliers 14 will supply consistently two things:

(a) Product

(b) Interactive data for interpretation.

This will create a situation where the farms 12 behave like contractors working to specific procedures and criteria.

The particular suppliers 14 will supply agreed data into the auditing facility 18 for reports to be generated for interpretation. In various embodiments, the agreed data will be delivered electronically to a computer system managed by the auditing facility 18.

2. Farmer Responsibility

A second aspect of a protocol initiated by the auditing facility 18 is that of ensuring farmer responsibility.

In the UK and all other dairy production countries milk recording is common amongst the top 50/60% of farmers. Currently in the UK farmers may have a contractor who visits once a month to take samples of milk, record yields from individual cows and also record movements of animals, health information and more if required.

Under the protocols described herein, the auditing facility 18 requires all farms 12 adhering to the protocol to have a regular recording days (e.g. once a month) to collect information. The information reported from this day could include:

a. Milk yield

b. Butterfat % and kgs (fatty acids profile if required)

c. Protein % and kgs

d. Lactose % and kgs

e. Cell counts (hygiene)

f. Animals born

g. Animals sold/died

h. Disease incidence

i. Treatment with pharmaceuticals

j. Numbers of cows in herd, in milk

k. Fertility information—in-calf cows, empty, non breeders

1. Regular (e.g. monthly) ration report for nutritional inputs

Legally a farmer's responsibility already covers retention of data for feed, vet, pesticides etc. The protocol does not require farms 12 to supply this information, only to allow the auditing facility 18 to communicate under confidentiality with their suppliers 14 to collect the correct formatted information for the auditing facility 18 to use. This can be a benefit of using particular suppliers 14.

3. Milk Purchaser Responsibility

The milk buyer 16 will record daily the volume of milk taken from each farm 12 and will bulk milk sample the tank at least once a week for detailed analysis for butterfat %, protein %, lactose %, water, antibiotics, urea levels and, if asked, fatty acid results.

The buyer 16 will then be required to daily input volume data to the auditing facility 18 for individual farms 12 and once a week send samples to a particular laboratory for compositional testing.

The importance of this information against historical and futuristic data is invaluable, especially if selling unique short life dairy products—level supply or recognised supply is essential.

On a monthly basis reports will be generated that will confirm volumes of milk on individual farms 12 for analysis.

4. Milk Testing Laboratory

From above, the milk samples at least once a week will be collected and tested, and the information from this will be directly imported into the auditing facility 18.

This will compare firstly with monthly on-farm milk recording but also with historical and predicted information.

For fatty acids, a once a month test would be required which will then form the basis for confirmation of specification of milk to the milk buyer 16 and subsequently the retailer and end consumer, but also for the analysis of cow performance and rumen function. Thus an audit trail for quality control is created.

5. Milk Records

Consolidating gathered data on both the supplier 14 and consumer 16 sides will provide reports which then can be interpreted for application and conclusion.

The various reports that can be produced may be of benefit as follows:

Production data can be obtained on yield, protein %, fat %, lactose %, and SCCs, all of which can be analysed by days in milk or month of calving (visualised by tables or lactation graphs);

All parameters may be compared for all cows against their predicted levels, and conclusions drawn on any deviations;

A milk production profile may be provided to graphically illustrate daily production, both historically and for months ahead;

Milk per cow per day against a forecast highlights impacts of feed changes, etc.

Number of cows in milk forecast may be used for feeding forecast/housing.

Herd companion service may be provided which highlights milk protein and SCCs issues.

Long term trends in calving interval, herd size, culling rate, fat and protein percentage etc.

6. Information Generation

This is an important function of the monitoring process as it highlights the information specifically required to interpret the on-farm processes.

Information generated includes:

a. Historical reports from particular suppliers—comparing last twelve months with current month, for example.

b. Prediction report—monthly updated sheets to provide predicted usage and production for the next month and the next six months, twelve months, or any other suitable period.

c. “Real-time” report—summarising what is actually happening in terms of inputs and outputs and allow:
stock control and re-ordering system;
health and welfare management;
nutritional management to evaluate current issues and anticipate future problems.

In general, these reports summarise:

current diets and feed amounts;

number of cows in herd;

number of cows in milk;

number of cows calved and culled;

number of cows served and pregnancy diagnosed etc;

number of specific health events and treatments.

To further improve information generation, the auditing facility 18 records and summarises information from the six key supplier areas discussed above:

Feed inputs and micro-ingredients information includes:

feed type and supplier

date delivery and tonnage

batch identity and expiry dates

storage legislation

analysis of ingredients

Fertiliser, seeds and pesticides information includes all of the above, plus:

recommendation on use (per unit or litres/hectare)

withdrawal period (where applicable)

crops treated by field

Pharmaceuticals information includes:

product name and code

unit size and number delivered

date of delivery

batch number and expiry date

standard withdrawal periods, meat and milk

dosage instructions, e.g. mls/50 kg b.w.

precautions for storage and usage

the name and contact details of the supplier

Most of these requirements can be provided in the form of “tote contents” barcode loaded directly into auditing facility system 18.

7. Interpretation

Reports compiled from the information generation are then formatted to give areas of comparison so that they can be audited.

Another reason for having particular suppliers 14 confirming inputs and using farm information on outputs is to confirm usage on farms 12, thus giving a robust audit trail and stocktaking facility along with standardisation.

There are five areas that help interpret the gathered information:

1. Input information

2. Output information

3. Cow dieting information

4. Farm predictions

5. Historical information

The information for interpretation may vary for each application of the protocol depending on exactly what is required.

Conclusions from interpretation are then drawn. The information that is generated in reports will be useful for the auditing facility 18 to remotely manage changes to any areas of supply to influence output. For example, by taking fatty acid profiles of milk the auditing facility 18 would be able to understand how the cows are performing from a metabolic point of view through rumen function. This information, along with dietary intakes, will give a picture of performance and the need for change, because generally the first indicators of anything going wrong, as with any animal, is a drop in feed intakes and subsequent production loss. In addition, information on the constituent make up of the milk will indicate whether there is undersupply of energy or protein which can be interpreted as a precursor to other health issues, e.g. acidosis, which is high acid loading in rumen leads to a drop in feed intakes, leading to a drop in fats, leading to rumen dysfunction, leading to health problems and, finally, loss of production.

The auditing facility 18 manages areas to do with data transfer and interpretation and makes available certain parts of the information to different organisations. The web server 28 allows password controlled access in this way, with only the auditing facility 18 having access to all.

The information and its use will be owned by the auditing facility 18 and used for farm 12 advantage, but also for the creation of robust traceability for the consumer 16 whilst giving the auditing facility 18 the ability to remotely manage dairy farms to produce milk to a particular specification.

In this way, the system 10 under control of a farm management protocol achieves greater transparency for all involved and gives greater confidence in natural production of food.

Some further details of a suitable Dairy Farm Management Protocol (DFMP) for putting the present disclosure into effect in a dairy farming environment will now be described. Various designs of a DFMP include:

Providing a management system to assist in the production of consistent quality and quantity of milk whilst improving the dairy cows' health and fertility performance; and

Improving the sustainability of dairy farmers by demonstrating and delivering improved efficiencies, reduction of costs and improved margins.

The DFMP utilises both a Code of Practice which needs to be dynamic for various occasions and a Data Capture Traceability System because the information received on and off of farm is the key to creation of consistent product. Suitable codes of practice and traceability systems will be described below.

Further aims of the DFMP are to create common farming practices so as to remove intervention of farm-individualised processes as much as possible and to produce food that is natural and sustainable.

The aims are achieved by industrialising production of milk off of farms. All farms and farming practices in some way are different. The DFMP gives guidelines conceptually to the production of animals and subsequently milk that meets a certain specification consistently. The DFMP is therefore dynamic and ever changing for the customers it works with.

Some of the general principles behind operation of the DFMP include:

1. Production of dairy animals of a certain type and production capability that are more likely to produce milk of a certain specification.

The parameters for the required outcome will be different on most occasions. The DFMP starts by using the milk spec/contract of sale to determine how animals are bred and which traits within the genetics of that animal are feasible for production of different milk specs.

For example, it would be possible to breed animals that are more likely to produce higher butterfats from the same nutritional inputs as other animals, thus giving better efficiency of utilisation of those nutrients.

2. Starting with a suitable animal, the DFMP then documents step by step how that animal is to be fed and treated so as to give it the best possible chance of producing successfully what is required.

The areas of attention include some basic codes of practice, e.g. spaces for feeding and resting, basic food rationing and consumption, etc., but also very specific parameters for growth and development of young animals to be used in different ways.

3. A dairy cow, as and when it gets to first calving, will be treated on the basis that it converts food nutrients into a specific type of milk.

4. Production and availability of food nutrients are a major part of the DFMP because the cow will only behave and customise ingredients that it is able to.

Detail of how certain forages are produced and obtained will be specific for each occasion and will probably be quite different for farms even trying to produce the same types of milk. For example, maize based diets will behave differently to grass based diets within the dairy animal, but with the correct supplementation of other feeds may well deliver the same specification of milk.

5. With the above in mind, and in order to be dynamic for various occasions, the control needed over inputs and outputs is relevant. Thus an appropriate Code of Practice and Traceability System are required to ensure the success of the DFMP.

The data that is supplied to the Traceability System forms the basis of how individual cow enterprises will be managed to create specific milk types.

6. Particular suppliers of materials will be used so as to control inputs to the farm further if necessary.

7. Once individual farms are directed on production of animals and inputs to farms and this data is being captured remotely by the auditing facility 18 under the DFMP, the ongoing monitoring of the production of specific milk then becomes the tool for remote management and change. This ultimately leads to greater consistency of product. The information generation and subsequent interpretation allows for remote management to succeed.

8. Providing farm professionals 14, such as a veterinarian and nutritionist, with the information from the DFMP will improve the decision making process for a farm 12 for the production of unique milk types—thus giving greater control.

9. The DFMP also delivers financial KPIs (key production indices) for benchmarking and assessment of farm efficiency by using the data provided. Again this delivers real-time information for decision making rather than historical data provided by management accounts.

To ensure that farm management protocols initiated by the auditing facility 18 are complied with, all entities involved in the system, such as farms 12 and suppliers 14, are required to follow a defined code of practice. An example form of a code of practice drawn up by “Farm First Ltd” to be adhered to by dairy farmers wishing to implement the protocol embodying the present disclosure is provided below:

Code of Practice

All suppliers of milk to Farm First Ltd and associated contractors (including their third party suppliers) are required to adhere fully to the National Dairy Farm Assured Scheme (NDFAS) and all related Legislation, Codes and Practices contained therein.

The following Code of Practice (COP) is an adjunct to the NDFAS and whilst in many places overlaps with this Code compliance with both schemes will be a mandatory requirement of the contract to supply milk to Farm First Ltd.

Introduction

The following Code of Practice (COP) sets out guidelines to assist in achieving the requirement that liquid milk products are produced to standards that are stricter than current legislation and also meet the customers' expectations. The code requires suppliers to take a responsible approach to the production of healthy, safe and quality products.

The code embraces all current and proposed legislation, regulations, codes of practices and guidelines.

Compliance

The COP should be strictly adhered to by ALL suppliers of liquid milk to Farm First Ltd (the company) as part of the supplier contract to the company. Failure to comply with the COP could mean termination of the supply contract.

Assessments

For compliance with the National Dairy Farm Assured Scheme, assessments will be carried out under their guidelines. It will be a requirement that all such assessments are made available to the company. The company will carry out random audits of farms to ensure full compliance with the COP and other legislative requirements.

Farm First Veterinary and Audit Visits

All suppliers of dairy products to Farm First should work closely with Farm First technical staff, to ensure that the requirements of all specifications and codes of practice are strictly adhered to.

Access to fields, storage areas and processing areas used for the production of raw materials for Farm First should be provided on request by Farm First.

Records should be accurately maintained and regularly updated at all times. Copies of all records should be available to Farm First on request.

Non-Conformance

Following an assessment or if any non-conformance has been identified that presents an immediate risk to the quality of the milk supplied to the company or the safety of the animals and /or farm workers then the company will have the right to suspend the supply contract with immediate effect. Such an action can only be lifted when satisfactory corrective action has been taken and verified.

If the Non-Conformance has been assessed to be non-critical then an action plan to rectify the situation should be agreed between the supplier and the company together with an acceptable timetable for correction.

Compliance with Legislation

All suppliers should comply with all current legislation relevant to their dairy farming business.

1.0 Origin of Stock

Design:

Farmers should be able to demonstrate a knowledge of the origin, and farming system, of all livestock reared for milk production for Farm First.

Therefore, it is relevant that stock records are up to date and that they contain all relevant information. Farmers should record the origin of all livestock.

1.1 Animal Movements:

Animal movement records on and off the farm should be retained for a period of not less than three years.

1.2 Replacement Stock:

For replacement stock, farm of origin and animal health treatment records for the whole of the animal's life should be available. Replacement breeding stock should be obtained from sources known to be practising good standards of husbandry and welfare.

Records should be maintained of the source of each animal together with any recent treatments. Under no circumstances should animals be bought on the open markets, from where traceability and records are unobtainable.

1.3 Disease:

Dairy products for supply to Farm First under the Oasis scheme should be sourced from stock which is guaranteed to be free from BSE.

1.4 Records:

All cattle should be identified to a standard that meets legislation. Ear tags and replacements should be documented.

All movements on to and off the farm should be recorded within 36 hours together with full details of pick up and drop down addresses.

Dates of birth and dam's official identification should also be recorded.

Insemination by stock bulls and sweeper bulls, whether resident or hired in, should also be recorded.

All above records should be available for inspection on request.

2.0 Husbandry and Welfare

Design:

All animals should be reared according to good husbandry and welfare practices and according to the relevant legislation in force in the country of origin and applicable EU standards.

2.1 Training

All owners of livestock are responsible for their welfare and should ensure that competent or experienced and knowledgeable staff is available at all times. All staff should undertake training in all aspects of stockmanship and all such training should be recorded. New staff to the farm should carry out an induction programme where training is given and a training programme prepared. Training should always be on-going and such a plan should reflect this.

2.2 Veterinary Assistance

Veterinary assistance should be available 24 hours per day and 7 days per week if required.

2.3 Stockmanship

The basic requirements for the welfare of livestock are a husbandry system appropriate to the health and, so far as is practicable, the behavioural needs of the animals and a high standard of stockmanship.

Stockmanship is a key factor because, no matter how otherwise acceptable a system may be in principle, without competent, diligent stockmanship, the welfare of the animals cannot be adequately catered for.

Stockpersons should be able to:

Recognise signs of normal behaviour, abnormal behaviour and fear.

Recognise signs of common diseases.

Apply the principles of sound animal nutrition and recognise digestive disorders.

Assess body condition by recognised scoring system.

Maintain normal healthy function of the foot by good foot care and treatment.

Maintain normal healthy udder function and recognise injury and disease.

Use hygienic practices in the parlour and dairy, and maintain equipment in good working order and a state of thorough cleanliness.

Recognise the signs of normal and abnormal calving, assist if required and care for the new-born calf.

Manage and maintain bulls, if appropriate, according to approved practice.

Where equipment is installed which affects cattle welfare (e.g. automatic scrapers, ventilation and milking equipment) stockpersons should be able to operate, routinely maintain and recognise signs of malfunction and know what to do in the event of equipment failure.

2.4 Systems

When considering livestock husbandry systems, provision should be made for the following:

Comfort and shelter.

Readily accessible fresh water and a diet to maintain animals in full health and vigour.

Freedom of movement.

Company of other animals, particularly of a like kind.

The opportunity to exercise most normal patterns of behaviour.

Light during the hours of daylight and lighting readily available to enable the animals to be inspected at any time.

The prevention or rapid diagnosis and treatment of injury, parasitic infestation and disease.

There should be no physical features of their environment which cause recurring injuries to cattle.

At all times, livestock should be treated and handled in such a way as to avoid injury and minimise stress, in particular the use of electric goads is not permitted.

Emergency arrangements to cover outbreaks of fire, the breakdown of essential mechanical services and the disruption of supplies.

2.5 General Practices

It is essential that close attention is given to the condition of feet, which should be regularly inspected for signs of abnormal wear, excessive growth or infection.

Disbudding of horned varieties using a hot iron is permitted to prevent injury, subject to the use of local anaesthesia.

Farm First recommend that identification of livestock is by ear tagging, slapmarking, tattooing or aerosol markers. Identification by ear notching, freeze branding, hot iron branding or caustic paste is prohibited.

Any potentially injurious husbandry procedures should be performed only when necessary and should be carried out in a way which minimises suffering and by trained and competent stock-keepers.

3.0 Feed Composition and Storage

Design:

All livestock should be fed and have access to a wholesome diet which is appropriate for their age, yield and body condition and stage of lactation so that it satisfies the nutritional requirements of the animal.

3.1 Nutrition Plan

A nutrition plan for the herd should be established based on advice from a reputable nutritionist. This nutrition plan should be updated at least three times a year and be available for inspection.

3.2 Grazing

Livestock should be grazed on pasture wherever possible. Pasture should be kept free of any debris or poisonous plants which could present a potential hazard to grazing animals.

Livestock should not be grazed on pastures where dogs roam, as chasing of animals by dogs leads to unnecessary stress and dogs can transmit parasitic diseases to cattle.

3.3 Feeds

Feed components should all be forage, vegetable or cereal based and may not contain animal or avian protein. Feed should be presented and kept in a clean and fresh condition.

The diet of cattle should include sufficient forage and fibre to allow them to ruminate; in adult cattle this should represent a significant proportion of their total diet.

3.4 Feed Source

All dairy rations including straights should come from an accredited supply source. A warranty should be obtained in writing from feed suppliers undertaking that upon demand, they are able and willing to trace back to source all ingredients supplied and that these rations have been produced according to all relevant legislation. Under no circumstances should feed containing GMO material be fed to animals which are to be used to supply Farm First.

3.5 Feed Records

Records for each delivery should be kept: these include all delivery documentation and ingredient declaration; these records should be kept for two calendar years. Feed deliveries should relate to your nutrition plans thus proving that your cows have been fed appropriately. All records should be available for inspection on request.

Diets should be mixed and dispensed accurately and quantities of feeds fed recorded daily.

3.6 Feeding Space

All cattle should have access to feeding trough space of which there should be sufficient to avoid bullying of shy feeders and to allow all cattle to consume their feed in the time allocated. Partitioning may assist in reducing bullying. All feed troughs should be cleaned out regularly.

Feed access is variable according to weight and size of cows.

3.7 Feed Storage

All feeds including straights, but excluding forage, should be stored in bins, lofts or bunkers where all reasonable steps are taken to ensure that they are bird-proof and kept bird-free, cool and dry but ventilated with no access by rodents or other animals. Storage should be regularly cleaned to remove dust and stale feed. Storage of loose feed (except hay and straw) in open barns is not permitted.

3.8 Water

Animals should have ready access to sufficient fresh clean water. Water troughs and drinking nipples should be designed so as to protect them from fouling, should be kept clean and should be checked at least once daily to ensure that there is a ready supply of water.

Water trough space should be in the range of 40-60 centimetres per head depending on the size of the animal, and based on Table 2 spacings there should be sufficient trough space for at least 10% of the herd to drink at any one time when animals are housed. When cows are at pasture, troughs should be positioned so that at least 30% of the herd are able to drink at any one time. The volume of water and flow rate to the trough should be adequate.

Provision should be made to ensure an emergency supply of suitable drinking water in the event of failure of the normal supply (i.e. due to freezing, drought, etc).

If the water source is from a bore hole, then such water should be analysed to ensure it is of suitable quality for livestock drinking use.

4.0 Housing and Handling Facilities

Design:

Farm First encourage extensive livestock rearing methods where animals have ready access to open pasture and are free to roam freely and express normal patterns of behaviour and mix with other animals of their own kind.

The proper housing of dairy cattle is particularly relevant to their productivity and well-being. Particular attention should be given to the proper housing of dry cows and in calf heifers.

Cattle should have sufficient freedom.

4.1 Housing Requirements

Where weather, breeding season or other conditions dictate that housing is in the best interest of animal welfare, the following requirements should be met:

Adequate shelter should be provided for livestock to protect themselves from the extremes of weather. Draughts through the lying or bedding area should be prevented.

Stock buildings should provide adequate air space which for adult cattle should be more than 20 cubic metres per head and pro rata for young stock.

Buildings should have effective ventilation allowing gentle air movement whilst substantially preventing the ingress of rain and snow. Natural ventilation is preferred using space boardings, or similar design, for at least one metre below the eaves or ventilated roof ridges. Airborne contaminants (dust, etc) should be kept to a minimum. Special care should be taken to ensure effective ventilation on still, humid days.

Stocking density should be in accordance with good farming practice and should allow sufficient space for animals to lie down simultaneously and without difficulty and freely stretch their limbs.

Water troughs in loose housing should be set on a solid base and positioned so that they do not wet the bedded area. The access to troughs should be concrete and well drained.

The interior of buildings, pens and fittings should be free of all sharp edges and protrusions which could cause injury to animals.

All electrical installations at mains voltage should be inaccessible to animals, properly earthed and regularly tested.

Walls, floors and fittings within the housing should be readily cleansable and disinfectable and maintained in a hygienic condition. Yard surfaces should be kept clean and scraped daily, e.g., more than once to avoid the build up of dung.

Paints and preservatives which may be toxic to livestock should not be used on any surfaces accessible to them. Particular consideration should be paid to the risk from old lead based paints.

Accommodation should be soundly constructed and provide adequate ventilation without causing unnecessary draughts. The thermal environment should not be so hot or so cold as to cause distress to the animals.

Passages should be of such a design and width that animals can pass freely.

Floors should be non slip and well drained.

A clean, well drained and dry lying area should be provided. Bedding in loose housing should be sufficient to avoid discomfort and to remain dry and to reduce the risk of environmental mastitis. Bedding in loose housing should be sufficient to avoid discomfort and to remain dry and to reduce the risk of environmental mastitis. Bedding should be removed and replaced sufficiently frequently to minimise heating and build up of bacteria to extent that may affect cow health. Removal at least every six weeks is recommended.

Adequate artificial lighting should be available to enable animals to be examined at any time.

Provision should be made for the segregation and comfort of sick or injured animals.

4.2 Cubicles and Straw Yards

Cubicle and straw yard accommodation is acceptable provided a regular assessment of cow comfort is carried out. There should be at least one cubicle per cow and should be an extra five cubicles per 100 cows or pro rata.

Cubicle housing should provide a clean, dry and comfortable bed, free from dung and urine. Adequate bedding up usually to a depth of 5 cms with appropriate materials should take place as and when required, usually daily, to maintain these conditions.

Cubicles should all have a sloped bed and all cubicles should be arranged in such a way that cows can lie down and rise easily without kicking or treading on adjacent animals. The size of cubicle should be in proportion to the size and weight of cows, so that they can stand and lie comfortably.

Cattle should be provided with sufficient space to lie down, adopt postures and social spacing patterns appropriate to the housing. In cubicle housing at least 1.5 times the lying area should be provided for loafing, and for straw yards 35% the bedded area.

Heifers should be acclimatised to cubicle housing and milking routines prior to first calving.

4.3 Handling

Staff involved in the handling of animals should always be quiet, assertive, attentive and, above all, patient. They should be well trained and experienced stockpersons with an adequate understanding of animal behaviours to avoid causing unnecessary stress to the animals.

Sticks should only be used when necessary, as an extension of the arm—never for hitting animals. Farm First prohibits the use of electric goads.

4.4 Pests

An adequate regime should be in place for the control of pests. It is strongly advised that a competent contractor is engaged for this purpose. Livestock should not be exposed to rodenticides or other pest control chemicals. Records of pest control inspections and treatments should be maintained for a period of two years.

4.5 Cleaning and Disinfectants

Housing, parlours and yards should be regularly cleaned and disinfected, using only approved chemicals where appropriate, to ensure good visual appearance, and to prevent the build up of infective material.

5.0 Milking Machine Maintenance

Design:

Milking machines and ancillary equipment should function properly and be capable of being thoroughly cleaned. They should not inflict injury, pain or discomfort on the cow or affect the quality of the milk.

5.1 Milking Requirements

The following precautions should be taken:

Avoid under- and over-milking.

Check teatcup liners weekly for roughness, elasticity and damage.

Replace liners every 2500 cow milkings or more frequently depending on usage, particularly where three daily milkings occur.

Ensure correct pulsation rate and ratio to meet liner specification given by the manufacturer.

Ensure correct vacuum regulation and control of fluctuation, clean the regulator weekly.

Have milking machine equipment serviced twice a year.

Have refrigeration and plant cleaning equipment checked twice a year.

Water temperatures and detergents/disinfectants, type and strength, should be checked at each cleaning.

5.2 Machine Testing

All milking machines should be inspected and statically tested in accordance with manufacturer's recommendations every six months. All certificates should be available for inspection on request.

5.3 Cup Liners

Teat cup liners should be changed every 2,500 cow milkings or when recommended by the manufacturer. Documents and invoices should be available for inspection on request to prove that changes have taken place.

5.4 Udder Cleaning

Teats should be clean prior to milking. Soiled teats should be washed in water containing disinfectant where appropriate, and then dried with a single use paper towel.

6.0 Herd Health, Medicines and Veterinary Treatments

Design:

All cattle should be protected from disease and when detected should be treated promptly, veterinary advice should be sought when necessary.

6.1 Medicines

All medicines should only be administered following the advice of a vet.

Details of all medicines used should be recorded at time of use. The following information should be recorded:

Date of purchase of medicine.

Name of medicine and quantity purchased

Batch numbers

Identity of animal or group treated

Date treatment started

Date treatment finished

Total quantity of medicine used

Length of withdrawal period

Earliest date of sale of animal or milk

Name of person administering medicine.

All above records should be available for inspection on request.

6.2 Facilities and Handling

Facilities for the segregation of sick and injured animals should be available.

Calving boxes or facilities for the proper assistance in the case of difficult calving should be provided.

Proper handling, hold and vehicle loading facilities should be provided.

6.3 Herd Health Programme (HHP)

A written herd health programme should be maintained and reviewed yearly involving a veterinary practitioner. The herd health plan/programme should identify the incidence of disease, illness or injury especially:

Fertility

Mastitis

Digestive disorders

Lameness

Conditions arising from inadequate or imbalanced nutrition

Injury from housing or environment.

The herd health plan should state the number of incidents and the trends. It should also state preventative and routine care and medication. The herd health plan and records should be available for inspection and kept for two years.

(It is advised to use the British Cattle Veterinary Association Herd Health Plan Version 3 dated October 2004, available via your Veterinary Surgeon)

6.3 Medicines

All medicines should only be administered following the advice of a vet.

Details of all medicines used should be recorded at time of use. The following information should be recorded:

Date of purchase of medicine.

Name of medicine and quantity purchased

Batch numbers

Identity of animal or group treated

Date treatment started

Date treatment finished

Total quantity of medicine used

Length of withdrawal period

Earliest date of sale of animal or milk

Name of person administering medicine.

All above records should be available for inspection on request.

All medicines and treatments should be stored securely in a locked room or cabinet in conjunction with the manufacturers' instructions, current codes of practice and legislative requirements.

All veterinary medicines may only be administered by a competent person or under supervision of a competent person whilst in training. Certain medicines may only be administered under the supervision of a veterinary practitioner or according to a veterinary practitioner's prescription. All legislation concerning the administering of medicines should be strictly adhered to.

6.4 Banned Substances

No veterinary medicines on the Farm First Banned Substances List (Appendix 1) can be administered to animals producing milk for Farm First.

Farm First will undertake residue testing of dairy ingredients to ensure that no medicines or veterinary treatments are detected.

6.5 Disposal of Medicines

Medicines which have exceeded their use-by dates should be disposed of in a responsible manner—ideally, returned to the veterinary surgeon or treatment supplier.

6.6 Sudden Deaths

All sudden deaths, diseases and animals culled as unfit should be recorded and reported to the veterinary surgeon for the appropriate investigation. The outcome and action should also be recorded. Dead livestock should be disposed of promptly and in accordance with current legislation.

6.7 Dogs

Farm dogs should be wormed regularly with a broad spectrum wormer, effective against tape and round worms.

6.8 Antibiotics

Farm First discourages the routine use of antibiotics, whilst recognising that good practice in animal welfare and food safety necessitates the availability of specific medication when required. The preventative use of veterinary medicines should only be in conjunction with good husbandry practices.

6.9 Organophosphates

Following recent concerns involving organophosphate active ingredients, all efforts should be made to use alternatives. Where no viable alternatives exist, then all precautions should be taken to protect the health of the staff involved in the treatment.

6.10 Treatments

All drugs and chemicals should be used exactly as stated on the product label and should be appropriate for the treatment needed.

All treated cows including dry cows should be clearly identified, e.g. tail tapes or spray markers, and all staff should understand how treated cows are identified.

6.11 Veterinary Advice

If the product is used differently to any of the instructions on the label, such as different dosage, frequency of use or length of treatment, veterinary advice should be obtained as withdrawal periods may be affected.

Veterinary advice should also be sought before using more than one product or preparation concurrently.

Antimicrobials and any prescriptive only medicines (POM) should only be obtained, dispensed and used under the supervision of a veterinary surgeon.

6.12 Withholding Periods

The withholding period specified on the data sheet for any product is that required for the product when used at the dose and frequency specified in the data sheet. If the product is used in any way outside that specified on the data sheet then milk should be withheld for a minimum of seven days. Longer withdrawal periods may be required for certain medicines or combinations of medicines, and veterinary advice should be taken.

Under no circumstances should milk from a treated cow be used until the withhold period has expired.

6.13 Feet

The feet of all cows should be regularly inspected for excessive growth, bruising, injury and infection and prompt action taken where necessary by a trained or experienced person.

6.14 Surgical Procedures

Surgical attention to cattle such as removal of supernumerary teats, disbudding and castration should be carried out either with veterinary advice or under veterinary supervision depending on treatment and legal requirements, and the age of the cattle. Surgical procedures should only be performed by trained and competent stockpersons, and in such a way that suffering is minimised.

6.15 Poisons

Farms should be regularly checked to ensure the absence of plants and weeds that are poisonous where they may be accessible by cattle.

All poisons should be stored in a locked container with appropriate labelling and health and safety advice in case of accidental contact.

7.0 Environmental Issues

Design:

To comply with all environmental legislation and codes of practice.

Farm First encourages its livestock suppliers to be good neighbours and to respect and protect the environment.

7.1 Waste

Animal waste should be handled in such a way as to minimise the risk of spread of disease to other animals or humans and in a way which avoids the danger of polluting the environment.

Other farm waste such as plastics, tyres etc should be stored and disposed of in an environmentally way complying with current legislation.

7.2 Pollution

Outdoor reared livestock should have access to clean pasture, where possible this should not be alongside motorways and other potential sources of pollution.

It is the responsibility of the livestock producer to ensure that any land used for grazing is free from contamination by heavy metals or any other potentially harmful contaminants. If there is any doubt, the analysis of soil samples is recommended.

Procedures for the safe use and disposal of all chemicals (e.g. organophosphates and synthetic pyrethroids) should be followed at all times.

No human sewage should be spread on pasture as this presents a risk of bacterial contamination/infection and can spread parasitic diseases.

8.0 Transportation

Design:

Whilst the welfare of cattle leaving the farm may not be under the control of the farmer, cattle markets, abattoirs and hauliers should in general conform to good welfare practice. All relevant legislation and codes of practice should be observed where farmers carry out their own haulage of cattle. Relevant records should be available.

8.1 Lorries

When loading and unloading, cattle ramps should be used which should not exceed 20 degree angle (usually a ramp 7-8 feet long to rise up to a lorry bed) and should be fitted with effective side gates and foot battens and should be covered with litter or straw. In most cases, the tailboard ramp of cattle lorries will meet this requirement, but this should be checked. This is to prevent slipping and panic during loading or unloading. These conditions should be observed at all times.

9.0 Traceability

Traceability systems should be maintained at all stages of the supply chain:

The traceability system should enable tracking of the product from farm to Farm First and also in reverse, from Farm First to farm.

Farmers should maintain stock records which identify specific animals and link them to veterinary treatments and confirm withdrawal periods.

Records should be obtained for the previous history of bought in stock. (See Section 1—“Origin of Stock”.)

Appendix

1.0 Chemical Standards

1.1 Chemical pesticide and agrochemical residue requirements are stated in the Generic Specification. Pesticide and agrochemical resides should not exceed 0.01 mg/kg (10 ppb) for any individual residue (including any relevant metabolite or breakdown product).

Notwithstanding this, a full list will be issued of veterinary items which are not permitted without written consent from Farm First.

In the event that the vendor's analytical limit of determination exceeds 0.01 mg/kg, the vendor should obtain approval from Farm First that the limit of determination is acceptable. Pesticide and agrochemical residues should not exceed the approved limit of determination.

1.2 Residual pesticide levels should be certified as compliant with the specification prior to delivery, using agreed methods of sampling and analysis traceable to a discrete, controllable unit of material, e.g.
a farm or herd
a batch of part processed product.

1.3 It is the responsibility of the supplier to maintain a record of all treatments used on animals and to make available to Farm First personnel treatment records when required.

1.4 Preservatives and all other additives, except where specified in the individual technical data sheets, should be absent.

1.5 Ingredient Chemical Standards and action limits are defined in RAG limits on individual technical data sheets.

1.6 Heavy Metals

The following apply:

| | | |
|---|---|---|
| Lead (Pb) | 0.02 | mg/kg |
| Arsenic (As) | 1 | mg/kg |
| Mercury (Hg) | 0.5 | mg/kg |

1.7 Mycotoxins

The following apply:

| | | |
|---|---|---|
| Aflatoxin M1 | 4 | ug/kg |
| Ochratoxin A | 4 | ug/kg |
| Zearalenone | 10 | ug/kg |

1.8 Veterinary Drugs

A full list of drugs which should not be used will be provided by Farm First. This list will be updated from time to time in accordance with legislative requirements and/or the discretion of the Farm First veterinary surgeon.

1.9 Any deviation from the list of chemical standards should be notified in advance to Farm First, for approval prior to delivery.

As will be seen, the above code of practice has been prepared based on farming practices in Great Britain. Different codes of practice will be appropriate for different countries and for different types of farm and the above form of a code of practice is provided for illustrative purposes only and should not be seen as limiting the present disclosure.

Another tool for ensuring that the protocol and the code of practice are adhered to is a traceability system which monitors inputs to and outputs from the farm 12.

The goals of the traceability system include:

providing total farm traceability and giving the consumer total confidence in the product.

providing the processor/retailer with a fully audited tracking system for dairy/beef/sheep or any other farm animals or outputs.

enabling a producer to comply with current legislation.

providing a producer with financial and management data to improve farm efficiency and profitability.

Data captured on a farm 12 includes:

herd recording data (yields/butterfats/proteins).

herd movements on and off farm for whatever reason.

KPIs (key production indices) that are practically based, not financial.

Farm inputs and outputs (feed, seeds, etc).

Stock movements (deadstocks).

Health information (mastitis, metabolic disasters etc).

Data for planning and trending.

A particular way to capture this data is for a recorder representing the auditing facility 18 to go onto farm every month to capture data for traceability purposes. This data is then kept at the auditing facility 18 rather than at the farm.

Some of the benefits of the traceability system include:

stockholding facilities (live and deadstock).

Predicitive data on a monthly basis against stocks and orders.

Actual performance through output.

Creates a different set of financial KPIs.

In addition to the data captured on the farm 12, the auditing facility 18 has a direct relationship with suppliers 14 and customers 16 of individual farms 12. Therefore data can be captured remotely from the farm directly into a central database at the auditing facility 18.

For example, suppose twenty-five tonnes of Hi-protein soya is delivered to a farm today. The supplier 14 of this feed would, at dispatch, communicate with the auditing facility 18 electronically all of the required details of that delivery. This information should correspond exactly with the on-farm record collected later. The information flow is therefore ‘real-time’. This means that it is possible to track deliveries of anything onto farms 12 on a daily basis.

The suppliers 14 would have to meet current legislation for supply of products and would be expected to survive thorough audits of systems beyond.

The database at the auditing facility 18 is set up on the same principles as that of the farm 12, so that flow of information between the farm 12 and auditing facility 18 can be two-way. This therefore gives another area of development where farm information can be checked against supplier and consumer information for audit purposes.

On a daily basis for traceability alone, information from suppliers 14 coming into the central database at the auditing facility 18 will be captured within the system and compared directly with the information received from the farms 12.

The farms 12 communicate all products coming onto farm at least once a month in the same way that data is received from suppliers 14 (via email or super-recorder). This allows consumers 16 to audit farms 12 remotely. Also, in the scenario of a potential product recall due to contamination of feedstuffs or drugs, it is possible to any farm outputs such as parcels of milk or individual animals that have been affected.

In summary, some of the advantages of the auditing facility 18 include:

Real-time capture of data;

Comparison of information between farms 12, suppliers 14 and consumer 16;

Robust and trustworthy audit trail;

Use of data to create KPIs for farm management decisions;

Identifying supply chain problems (food scares, etc.)

Ability to audit traceability remotely from the farm 12.

FIG. 2 illustrates some of the processes followed in an example computer program 100 that may be run by an auditing facility 18 in order to achieve the goals set out above.

The StockMatch 102 front end of the computer program 100 permits a user to perform a number of actions. A user analyse supplies 104 being delivered to farms 12, in which case particular criteria are selected 106 and reports are generated on paper, by fax or by email 108. An excel attachment containing information of supplies delivered to farms may be imported 110 into the computer program. This is then loaded into the office record 112 before the uploaded information is deleted 114. The office record itself may also be analysed 116 and reports generated on paper, by fax or by email 118. Similarly, farm records can be analysed 119 and reports generated on paper, by fax or by email 120. The farm record and office records can be reconciled with one another 122 and, again, a report can be generated on paper, by fax or by email 108.

The StockMatch 102 front end can also be used to register supplies 126 and suppliers 128 for farms 12. The linked herd can be changed 130 and details of the linked herd 132 supplied for the reconciling process 122.

Embodiments of the present disclosure have been described to assist a suitably skilled person in understanding the disclosure. However, these embodiments should not be seen as placing any limitation on the present disclosure.

1. A method for managing a farm comprising:
determining a particular output for a farm;
developing a farm management protocol;
developing a code of practice;
tracing inputs to and outputs from the farm;
managing the inputs to the farm under the farm management protocol and the code of practice in order to achieve the particular output for the farm.

2. The method of claim 1 wherein the farm management protocol comprises particular guidelines to be followed on a farm to achieve the particular output.

3. The method of claim 2 wherein the code of practice describes general farming practices that should be adhered to on a farm to ensure that following the farm management protocol will result in the particular output being achieved reliably.

4. The method of claim 2 wherein the farm management protocol comprises a list of particular suppliers of inputs to the farm.

5. The method of claim 1 wherein the farm management protocol comprises guidelines for recording the inputs to and outputs from the farm.

6. The method of claim 1 wherein the farm management protocol describes responsibilities of any of: the farm, suppliers of the inputs to the farm, and buyers of the outputs from the farm.

7. The method of claim 1 wherein determining a particular output for a farm comprises determining a particular specification of milk to be output from the farm.

8. The method of claim 1 wherein the farm management protocol comprises guidelines for regular testing of the outputs from the farm.

9. A computer system for monitoring a farm, comprising:
an inputs module for receiving data relating to inputs to the farm;
an outputs module for receiving data relating to outputs from the farm;
a report generation module for generating at least one report relating to the inputs to and outputs from the farm.

10. The computer system of claim 9 wherein the inputs module is further for receiving data relating to use of inputs on the farm.

11. The system of claim 9 wherein the at least one report is an historical report of inputs to and outputs from the farm.

12. The system of claim 9 wherein the at least one report is a forecast of future inputs to and outputs from the farm.

13. The system of claim 9 wherein the at least one report is a health and welfare report.

14. The system of claim 9 wherein the at least one report is a report showing a distribution of a contaminated substance in a supply chain.

15. The system of claim 9 wherein the computer system further receives information describing a particular output from the farm and the at least one report contains recommendations for inputs to the farm to achieve the particular output.

16. The system of claim 9 wherein the data relating to inputs to the farm is received from suppliers supplying the inputs to the farm.

17. The system of claim 16 wherein the data relating to the inputs to the farm is further received from the farm on a regular basis.

18. The system of claim 9 wherein the inputs to the farm include any of: pesticides, micro-nutritional ingredients, pharmaceuticals, commodities, veterinary services, breeding services and dairy hygiene services.

19. The system of claim 9 wherein the outputs from the farm comprise milk.

20. The system of claim 9 further comprising a web server for storing the reports and making them accessible via a computer network.

21. The system of claim 9 wherein the inputs module is for receiving data relating to inputs to a plurality of farms, the outputs module is for receiving data relating to outputs from the plurality of farms, and the report generation module is for generating at least one report relating to the inputs to and outputs from at least one farm selected from the plurality of farms.

22. A method for monitoring inputs to a farm, comprising:
communicating information identifying inputs to a farm from the farm and from at least one supplier of inputs to the farm to an auditing facility; and
auditing inputs to the farm at the auditing facility.

23. The method of claim 22 wherein the auditing facility is independent of the farm and of the at least one supplier.

24. The method of claim 22 wherein the at least one supplier is a particular supplier agreed to by the auditing facility.

25. The method of claim 22 wherein the information is communicated to the auditing facility electronically.

26. The method of claim 25 wherein the information is communicated to the auditing facility by email.

27. The method of claim 22 wherein the at least one supplier communicates information identifying inputs to the farm at the time of dispatch to the farm of the inputs.

28. The method of claim 22 further comprising:
communicating information describing outputs from the farm to the auditing facility;
analysing the inputs to and the outputs from the farm at the auditing facility; and
generating a report based on the analysis.

29. The method of claim 28 wherein the report comprises instructions for farm management.

30. The method of claim 29 further comprising determining particular outputs from the farm and wherein the instructions are instructions concerning inputs to the farm to achieve the particular outputs.

31. The method of claim 22 wherein auditing inputs to the farm comprises:
conducting a search at the auditing facility for a contaminated substance in the inputs to the farm.
